(19) United States
(12) Patent Application Publication
(10) Pub. No.: US 2007/0050177 A1
(43) Pub. Date: Mar. 1, 2007

(54) Methods and Systems for Accessing Code Information

(76) Inventor: James R. Kirkland JR., Smyrna, GA (US)

Correspondence Address: NORA M. TOCUPS, P.O BOX 698, 140 PINECREST AVE, DECATUR, GA, 30030, US

(21) Appl. No.: 11/467,533

(22) Filed: Aug. 25, 2006

Related U.S. Application Data
(60) Provisional application No. 60/711,119, filed on Aug. 25, 2005.

(51) Int. Cl. G06F 17/50

(52) U.S. Cl. 703/1; 705/7; 345/619

(57) ABSTRACT

Provision of access to and possible information about one or more parts of a code or codes and/or other regulations that may be based on geographic location and relevance to a feature selected from an exemplary or other set of project plans. Features in the set of plans may be selectable. Information may be displayed based upon a selected feature and geographic location. Information may include part(s) of code(s) and/or other regulations relevant to the selected feature and geographic location, associated information, and illustration(s). The information may be displayed with or without the selected feature, in various formats, and/or selectively undisplayed to return to display of the selected feature or other display. The displayed information may include selectable elements associated with element information that also may be displayed such as in a cascade.

### RELATED APPLICATION

This application claims priority to and the benefit of the prior filed co-pending and commonly owned provisional application entitled “Methods and Systems for Accessing Building Code Information”, which was filed with the United States Patent and Trademark Office on Aug. 25, 2005, which was assigned U.S. patent application Ser. No. 60/711,119, and which is incorporated herein by this reference.

### FIELD OF THE INVENTIONS

The inventions relate to quick and easy access to select building code information from a compendium of information, and in particular, relate to quick and easy access to select building code sections, sub-sections, paraphrases, illustrations, and/or explanations. Generally, the inventions may relate to any kind of code or regulation and quick and easy access thereto.

### BACKGROUND

Construction of a building and other work such as renovation, repair and demolition generally requires knowledge and understanding of building codes and other rules and regulations pertaining to the work. There are, however, difficulties in acquiring the necessary knowledge and the understanding. The same difficulties apply to the acquisition of knowledge and understanding of other types of rules and regulations such as may be suggested, applied or enforced by local, state, federal and even international governments and agencies and other authorities or groups. Examples may include rules of local homeowners associations, municipal fire codes, state and federal environmental protection agency (EPA) regulations, health and safety regulations (OSHA), etc.

A first problem is the determination of which codes, rules, ordinances, laws, statutes, by-laws, or other regulations may govern or relate to the work. Geographic location may be a determining factor in which code or codes cover a project. One or more codes may cover the work based on the geographic location of the building or other project. For example, if a building is to be built within a municipality within a county and within a state, then municipal, county and state rules and regulations may all cover the work.

Another determining factor in which code or codes cover a project is the nature of a particular aspect or feature of the building or other project. As with geographic location, the nature of a particular feature may be covered by one or more building codes. As an example, construction of a chimney on a building may be governed by a municipal fire code as well as a local building code, and also local real estate covenants. Other determining factors may include the type of work such as demolition, site clearance, versus construction, and so on. Other factors might include segments of the construction or project process such as a separate plumbing code, a separate electrical code, and a separate heating and air conditioning code. Thus, the determination of which code or codes govern the work may be a complicated process that involves consideration of many factors such as geographic location, nature of particular aspects or features of the work, the type of work, and trades involved.

The process of determining which codes apply to a particular project may be further complicated by the organization and presentation of codebooks and other compilations of regulations and the like. Generally, such materials are organized and presented in a manner convenient to the author such as the issuing authority and not necessarily convenient nor intuitive to the end user. To save on expense or for other reasons, a codebook may fail to include or include only minimal research tools such as an index, table of cross-references, and glossary, thereby making such research and determination of applicable provisions more difficult.

The complicated process of determining which codes apply to a particular project is often beyond the capabilities of many of the work teams involved with the projects. An option is to retain an expert to carry out the determination of which codes apply to a particular project. This option, however, may add considerable expense to the overall project as well as delay or otherwise impede the progress of the project especially if the expert is not in sync with the work team. Thus, this option may be skipped or not completely utilized.

As a result, applicable building codes may be ignored or otherwise violated in whole or in part. These violations may or may not be discovered upon inspection by governing or other authorities. If discovered, the violations may be costly in terms of time, money and effort to correct. If undiscovered, the violations may risk aspects and features of the project, may cause unnecessary current or later problems, and may even endanger the health and safety of the work team on the project and any users of the completed project. In the case of fire and environmental and similar type code violations, the community may be endangered. The endangerment to health and safety may extend well beyond the life of the project or even the building constructed such as in the contamination of ground water or other resources.

Even if the codes and regulations applicable to a particular project are successfully determined, there remains the problem of accessibility. Compilations of codes and regulations are generally made available by their issuing authorities. Their availability may be only in paper form such as in the case of code books, and may be available only for purchase or available in a library. Typically, codebooks and other compilations are only issued on a yearly basis, yet parts of the code may change more quickly through amendment, expiration or otherwise. Thus, a codebook may be out-of-date at least in part as soon as it is issued and the user may have to consult other resources for up-to-date portions of the code. These other resources may be paper updates provided by the issuing authorities upon request, but not necessarily provided without such request and possible payment. Some issuing authorities may provide access to compilations of codes and regulations in an on-line format, including updates, but this type of access requires at least computer literacy on the part of the user.

A problem faced by a user even if he or she has determined which codes are relevant and has access thereto is the understanding of the code provisions. A code or regulation is generally drafted in legal language and may be drafted using terms having specific meaning for a particular field or area. Thus, a user may find it difficult to understand or interpret a particular code provision. This difficulty may be exacerbated if the code provisions are not drafted well, if the user's reading and interpretation skills are limited, if the language of the code provisions is not the primary or well understood language of the user as well as for other reasons.

The meaning of a code provision may be further clouded and its understanding delayed or prevented by inclusion of citations to other portions of a code not immediately contained in the code provision under review. A user may have to flip back and forth between and among various pages of a codebook to glean understanding of a particular code provision. The user's effort to gain understanding may be further challenged by the general use of relatively small font size and dense text in code books to save on the expense in producing them. Continued use of a particular code book by a work team may result in a worn out copy with code portions that may have become obscured through wear and tear and may even be missing.

In sum, there is a need for methods and systems that provide relatively ready, easy access to codes and other regulations, and that may provide information in aid of understanding such codes and other regulations. There is a particular need for methods and systems that aid in the determination of which codes and other regulations govern, cover or are otherwise applicable to a particular project, and that provide such aid in an economical, convenient, and efficient manner.

### SUMMARY

Stated generally, the inventions relate to providing access to and possible information about one or more parts of a code or codes and/or other regulations that may be based on geographic location and relevance to a feature selected from an exemplary set of plans. More particularly, a set of plans relating to a project may include selectable features. Each selectable feature is associated by link or otherwise with code information. Upon selection of a feature, the code information is displayed. The code information may include a relevant part or parts of a code and/or other regulations as determined by a geographic location that may be supplied by the user or otherwise determined. The code information also may include associated or explanatory information, and may include illustration(s), graphs, tables, and the like. Further, the code information may include one or more selectable elements. Each of the selectable elements is associated with element information that may be displayed with the code information such as in a cascade or otherwise. The code information may be displayed with or without the selected feature, in various formats, and/or selectively undisplayed to return to display of the selected feature, other display, or otherwise. The inventions may be implemented in computer software for ease of use.

Advantageously, the inventions provide relatively ready, easy access to codes and other regulations, and may provide information in aid of understanding such codes and other regulations. The inventions aid in the determination of which part of a code or codes or other regulations govern, cover or are otherwise applicable to a particular project, and provide such aid in an economical, convenient, and efficient manner.

A particular advantage of the inventions is that they may aid in the determination of and access to part or parts of a code, codes and/or other related regulations based on a characteristic associated with a project such as a geographic location. Thus, a user may supply a geographic location such as by input of a zip code and be presented with code information relevant to that location.

Another particular advantage of the inventions is that code information may be accessed in a manner that is compatible with the manner in which most people think. A user does not have to search through codebooks and other compilations that may be poorly organized or include minimal or faulty research tools. A user does not have to retain the services of an expert that might add cost and time and effort to the project. A user does not have to take time from a project to contact a regularity authority for pertinent code or regulation information or explanation. Nonetheless, the user does not have to fear missing an important code or other regulation relating to a feature of a project. Nor does the user have to maintain a library of codebooks, municipal codes, and other compilations of regulations relating to a project or maintain update services for each of the regulatory materials. Further, a user does not have to worry about missing parts, obliterated or out-of-date sections in a codebook or book of regulations. Rather, the inventions may be implemented in computer software so as to provide complete up-to-date code information to the user in a convenient, easy-to-use manner.

Yet another advantage of the inventions is that the code information may include information in addition to the relevant part or parts of a code or codes or other regulations. This other information may include associated or explanatory information, illustrations, tables, graphs, commentary, or the like. This other information also may include or include links to topics that may be referenced or cited as part of the relevant part or parts of the code or codes and/or other regulations. Advantageously, the user may be able select elements from the code information so as to obtain even further information.

There are many additional advantages of the inventions. One of these is that the availability and use of the inventions may increase the rate of compliance with codes and other regulations in many types of projects. Increased compliance with codes and other regulations has many benefits including higher quality in project completion as well as fewer failed inspections, thereby saving time and money lost in correcting code related errors. Time and money also may be saved on maintenance if the project is completed in compliance with applicable rules and regulations.

Advantageously, the inventions provide a resource to supervisors and owners of projects to use to monitor the progress of their projects and compliance with applicable codes and regulations. The inventions may smooth relations among contractors, tradespeople, supervisors, and owners by serving as an expert resource recognized by all parties.

The inventions also may serve ultimately to better existing codes and regulations and improve future editions. Such betterment and improvement may be brought about by greater interest in codes and regulations as a result of the convenience and ease in use of the inventions. Technologies that may have been hampered previously by being considered too “code-intensive” or regulated may be boosted or see a boom as a result of the implementation of the inventions.

More particularly, an exemplary embodiment of the inventions provides access to and possible information about a code that may be relevant to a feature in a set of plans and that may be based on geographic location. An exemplary set of plans may display one or more exemplary selectable features. Code information may be displayed based upon a selected exemplary feature and identified geographic location. The code information may include at least a part or parts of a code or codes relevant to the selected exemplary feature and the identified geographic location, and also include associated information such as an illustration.

In the exemplary embodiment, the exemplary set of plans may include one or more pages with a page including at least a plan relevant to the exemplary set of plans. One of the pages of the exemplary set of plans may include or be a cover page having selectable items including an index, a site plan, or one or more lists of topics of code information. Each selectable item is associated with respectively relevant information. When an item is selected, relevant information associated with the item is displayed.

The exemplary embodiment also may include an undisplay button when the code information is displayed. When the undisplay button is activated, the code information may be undisplayed or otherwise removed from display. This exemplary embodiment also provides that the code information may be displayed with display of the selected exemplary feature in a split screen format or otherwise such as without display of the selected exemplary feature.

In addition, the exemplary embodiment may provide that the displayed code information includes one or more selectable elements with each selectable element being associated respectively with relevant element information. In response to selection of an element, the associated relevant element information is displayed, and such display may be in a cascaded fashion with the display of the code information or otherwise.

The inventions include another exemplary embodiment, which provides code information related to a particular project. In this exemplary embodiment, one or more features in the particular set of plans relating to the particular project may be identified and associated respectively with links to an applicable part or parts of code information. The code information may include a part of a code related to an associated identified feature, and may include explanatory information. The code information may be derived at least in part from geographic information relating to the particular project. Further, the code information may be taken from one or more codes or regulations. In response to activation of a link associated with an identified feature, the applicable part of the code information associated with the identified feature is displayed.

In yet another exemplary embodiment of the inventions, one or more features from an exemplary set of plans is or are associated respectively with links to code information. In response to activation of a link associated with a feature, code information is displayed and that code information may be based on a provided zip code.

A further exemplary embodiment of the inventions includes a method to present one or more parts of a code relevant to a feature in a plan. Per the exemplary method, a request for code information may be received with the request identifying a geographic location and a feature from a plan. The geographic location and the feature are used to determine one or more parts of one or more codes. The code information as determined from the identified geographic location and the feature from the building plan is displayed.

Yet another exemplary method of the inventions provides a source of information about regulations governing features in a plan. The exemplary method compiles regulations relating to exemplary features of an exemplary plan. Feature information is associated with respect to each exemplary feature. The feature information may include one or more regulations relevant to an associated exemplary feature and may be based on geographic location. The exemplary plan with the exemplary features having associated feature information may be made available as a source of information.

### BRIEF DESCRIPTION OF THE DRAWINGS

FIG. 1 is an illustration of an exemplary environment in which an exemplary embodiment of the inventions may be used.

FIG. 2 is an exemplary cover page as may be used as part of an exemplary set of plans as part of an exemplary embodiment of the inventions.

FIG. 3 is an exemplary page including exemplary elevations and sections as may be used in an exemplary set of plans as part of an exemplary embodiment of the inventions.

FIG. 4A is an exemplary enlarged view of an exemplary feature from the exemplary page illustrated in FIG. 3.

FIG. 4B illustrates exemplary code information as may be presented in response to selection of the exemplary feature illustrated in FIG. 4A.

FIG. 4C illustrates exemplary code information as may be presented in response to selection of the exemplary feature illustrated in FIG. 4A.

### DETAILED DESCRIPTION

The inventions are described below in more than sufficient detail for a person skilled in the art to make or use the inventions. The inventions are described by reference to exemplary embodiments including systems and methods. The inventions, however, should not be limited to these embodiments, but may also cover other systems and methods (not specifically described) in accordance with the inventions. Moreover, the exemplary embodiments are described below with reference to use in the building industry, but the inventions should not be limited to a single industry. The inventions may be useful in many different types of industries and applications.

The inventions are further described below as implemented in and used with computer software, and specifically, as an application program that may be used on a personal computer. Again, the inventions should not be limited to this specific implementation, but may be otherwise embodied.

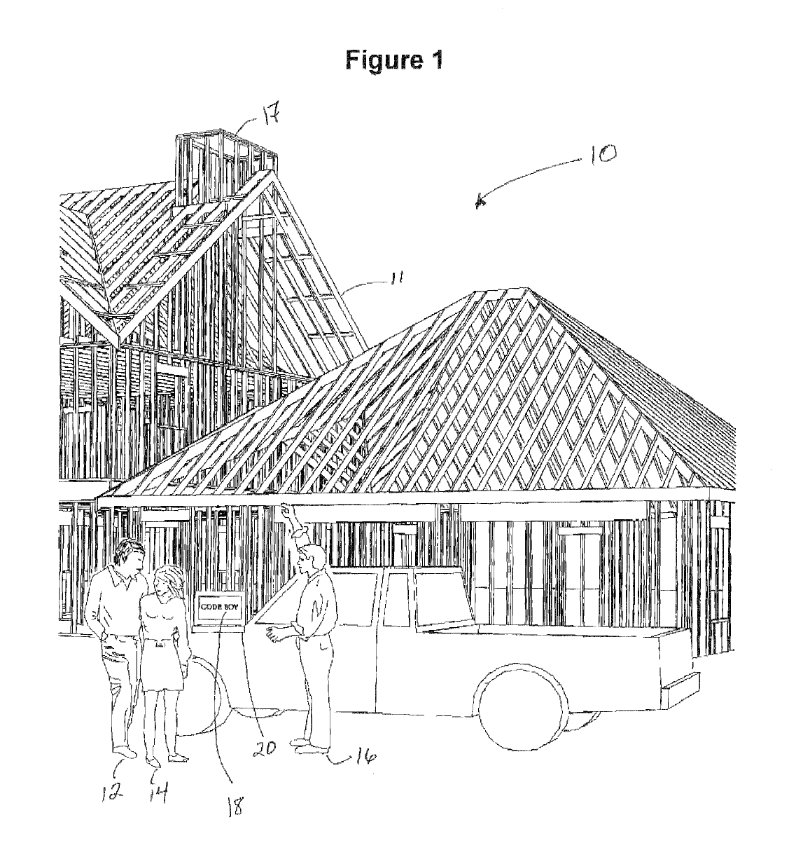

FIG. 1 illustrates an exemplary environment 10 and subject matter as may be used in an exemplary embodiment of the inventions. In this example, a home 11 is under construction, and the potential homeowners 12, 14 are meeting with their project manager 16. Assume an issue has arisen regarding the compliance of the chimney 17 of the home 11 with the International Residential Code® for One—and Two-Family Dwellings*. Advantageously, the homeowners 12, 14 and the project manager 16 may use an exemplary embodiment of the inventions as implemented in a software application referred to as CODE BOY™‡ 18 and as may be used on a portable computer 20 to resolve the compliance issue relating to the chimney 17.
* The International Residential Code® for One- and Two Family Dwellings is a copyrighted work owned by the International Code Council, Inc. The trademarks International Residential Code and the International Code Council are registered trademarks of the International Code Council, Inc.

‡ CODE BOY™ is a trademark of Clarity Technologies LLC.

More particularly, the home owners 12, 14 and the project manager 16 may access the software application 18, provide information on the geographic location (and/or other characteristic) of the home 11, and select the exemplary chimney feature in the exemplary set of plans provided by the software application 18. Upon selection of the chimney feature, the software application 18 displays associated code information. The homeowners 12, 14 and the project manager 16 may consult the code information provided by the software application 18 to resolve the issue related to the chimney 17 in the home 11. Further details regarding the use of the exemplary software application 18 to the chimney compliance issue are provided below.

As noted, the home owners 12, 14 and the project manager 16 may access the software application 18 for code information related to the chimney 17 of the home 11. The software application 18 may present an exemplary set of plans for an exemplary building with the set of plans including features at least one of which may be selected by activation or otherwise to obtain further information. Selection of a selectable feature results in a display of code information relevant to the selected feature and that has been linked or otherwise associated with that feature based on geographic location and/or otherwise. Of course, the exemplary set of plans may include features that are not selectable, but does not have to.

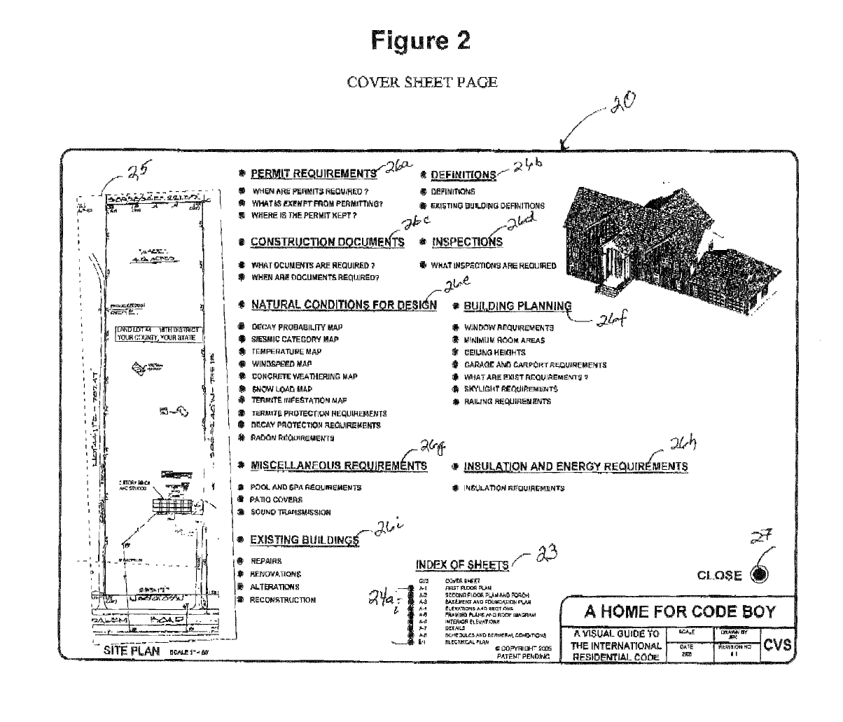

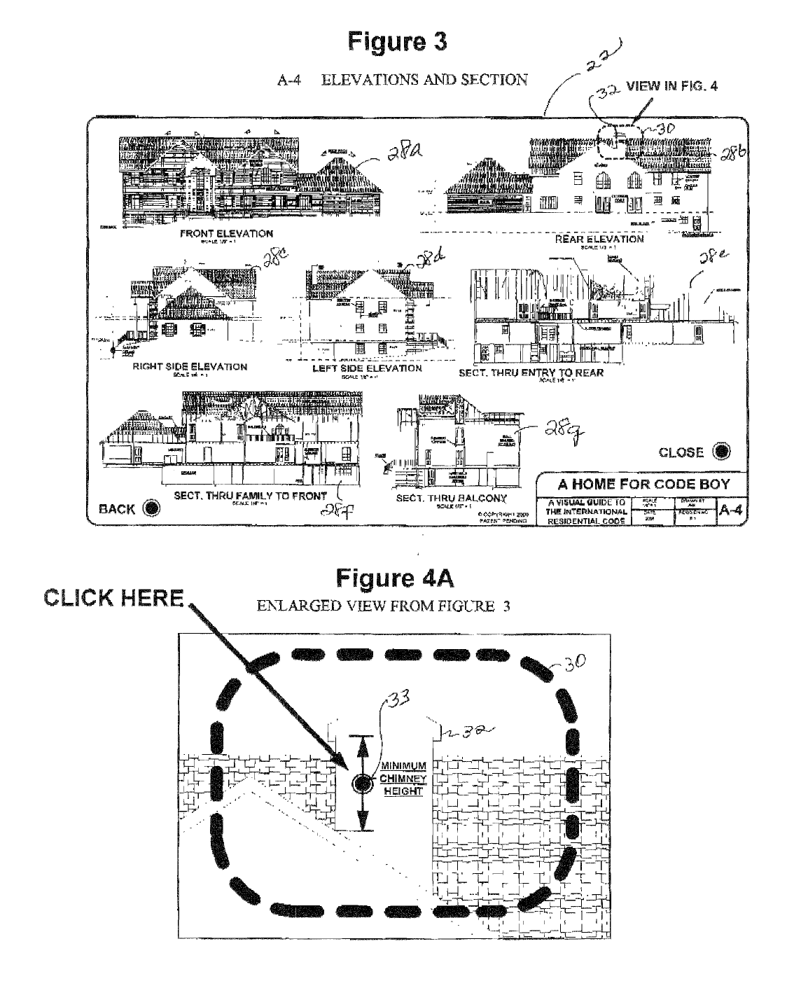

In the example used herein, the exemplary software application 18 includes an exemplary set of plans with a cover sheet 20 as illustrated in FIG. 2 and a page 22 including Elevations and Sections relating to the exemplary building as illustrated in FIG. 3. The inventions, however, should not be so limited. The exemplary set of plans may include one or more pages as appropriate to the exemplary building. For example, the exemplary set of plans may include a cover page with general and reference information, and a page for a site plan, a page for each elevation, a page for each section, a page for each floor plan, and so on as appropriate for convenience and ease of use of the inventions. Another exemplary set of plans may be organized differently. An embodiment of the inventions may include more than one set of plans, but does not have to.

The exemplary building in the example used herein is a home, but the inventions should not be so limited, and may be educational or medical institutions, commercial developments, industrial complexes, entertainment venues, etc. Moreover, the example refers to only a single building, but implementations of the inventions may include more than one building and/or other structures or projects with or without correspondingly more than one set of plans in the software application. Further, the example used herein provides an exemplary set of plans for a whole exemplary building, but the inventions may be implemented differently by featuring a selected part or parts of one or more buildings or other projects.

As noted, the exemplary set of plans includes features that may be selected by activation such as by clicking on a link or otherwise to obtain information associated with a selected feature. An exemplary chimney is used as the feature in the example herein to explain the operation of the exemplary embodiment. Other features may include other items present in the exemplary set of building plans such as doors, windows, stairways, landings, plumbing fixtures, electrical devices, structural diagrams, and illustrations showing such features of the structures, building or projects including joists, studs, or wall coverings, interior elevations showing such features as cabinets, electrical device positions, plumbing fixture positions, and any other item pertinent or as may be included in the construction, project, structure and/or building included in the set of plans. Additional or other features may be used in other sets of plans depending on the nature of the project, which is the subject of the set of plans. In some cases, a feature may be a combination of two or more items (each of which may be features) or otherwise relate to more than one item.

In the example used herein, the information associated with a feature is referred to herein as code information and may include part or parts of a code or codes or other regulations relating to the associated feature. As used herein, a code refers to one or more rules that relate to a feature(s) or other aspect(s) of a building or other project. An example of a code is the International Residential Code® for One- and Two-Family Dwellings referenced above. The term “code” as used herein is used synonymously with the following terms (unless exception is made): by-laws, canons, decrees, guidelines, laws, ordinances regulations, rules, statutes and like terms. Also, the term “code” may be used herein to refer to any part, paragraph, section of a code.

In addition to part or parts of a code, the code information also may include other information such as explanatory or illustrative information including tables, graphs, graphics, charts, diagrams, illustrations, drawings, commentary, measurements, measurement conversions, tips, how-to's, scale and other reference information, material or product recommendations, and the like. This other information also may include text and graphics that may be cited in the part or parts of the code or codes or other regulations relating to the feature.

Reference now is made again to the example of the home owners 12, 14 and project manager 16 using the exemplary embodiment of the inventions in the form of the software application 18 to resolve compliance issues relating to the chimney 17 of the home 11.

FIG. 2 illustrates an exemplary cover sheet 20 as may be presented by the software application 18 and as may be used by the home owners 12, 14 and project manager 16 to begin resolution of the chimney compliance issue. The exemplary cover sheet 20 is one page of an exemplary set of plans for an exemplary building as presented by the exemplary embodiment of the inventions. To aid in accessing the relevant information, the exemplary cover sheet 20 includes an index of sheets 23 listing all of the pages 24a-i (also referred to as sheets) of the exemplary set of building plans. Each of the pages 24a-i may be accessed by activating a particular page identifier such as by clicking on the name of the page or corresponding button. As explained below, the home owners 12, 14 and project manager 16 choose to access the page referred to as A-4 Elevations and Sections 22 so they activate the button or name of that page 24i as presented on the cover sheet 20.

Still referring to FIG. 2, the cover sheet 20 may display information in addition to or other than the index of sheets 23. In this example, the cover sheet 20 also displays a site plan 25 for the exemplary building, and exemplary lists of topics 26a-i that may be relevant and/or of interest relating to the exemplary building in the exemplary set of plans or otherwise. The exemplary lists of topics 26a-i on cover sheet 20 include: permit requirements 26a; definitions 26b; construction documents 26c; inspections 26d; natural conditions for design 26e; building planning 26f; miscellaneous requirements 26g; insulation and energy requirements 26h; and existing buildings 26i. Each list 26a-i includes a title for the list and one or more topics included in the list. In this example, a user may indicate a selection by clicking on the title of a list for more information about that list, and/or may indicate a selection by clicking on a topic within the list to access the information as associated with the activated topic. The information presented to the user in response to the selection of a title of a list or a topic from the list may be code information, and/or other information.

The exemplary cover sheet 20 as illustrated includes, but does not have to, a “close” feature 27, which may also be referred to as a selectable undisplay or back button. To remove the exemplary cover sheet 20 from view, the user may select the close feature 27 by clicking on it or otherwise activating it.

All of the information displayed by the exemplary software application 18 and as illustrated herein is presented in static, black & white, two-dimensional format, but that does not have to be the case. Exemplary embodiments of the inventions may be made to display information that is dynamic, may include video and sound, may be in color, and may appear to be three-dimensional. Moreover, all of the information is presented in English, but a user may have the option of displaying all or part of the information in one or more other languages.

In the example of the chimney compliance issue, the home owners 12, 14 and project manager 16 have selected to view exemplary sheet A-4 Elevations and Sections 22, and in response to that selection, the sheet 22 as illustrated in FIG. 3 is displayed. In particular, FIG. 3 displays a front elevation 28a, a rear elevation 28b, a right side elevation 28c, a left side elevation 28d, a section thru entry to rear 28e, a section through family to front 28f, and a section thru balcony 28g.

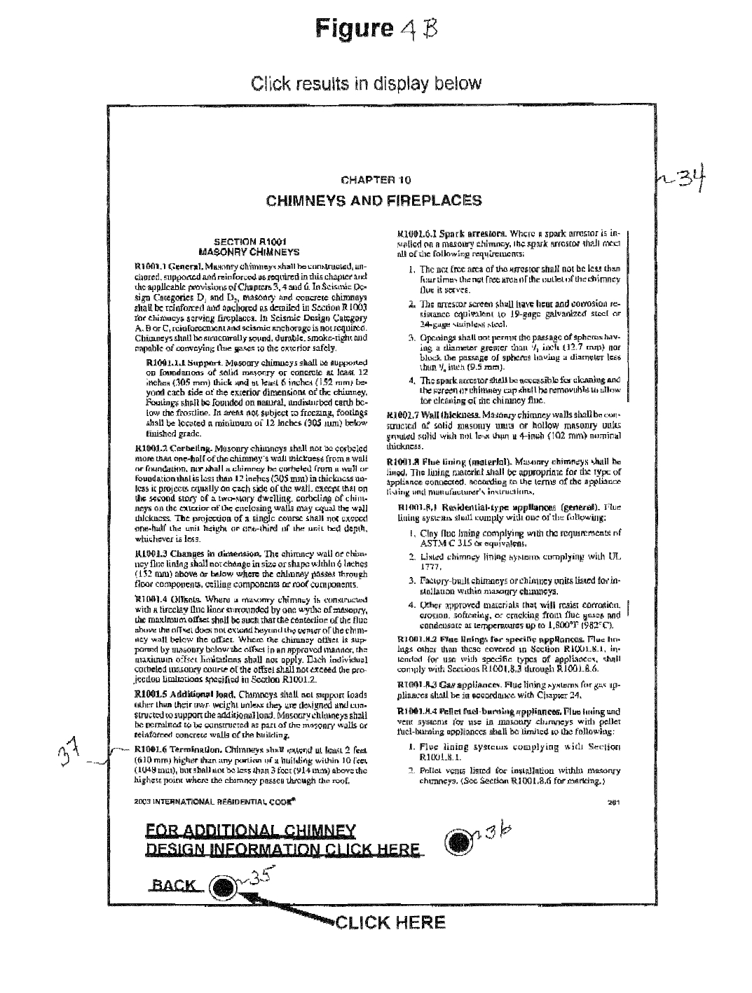

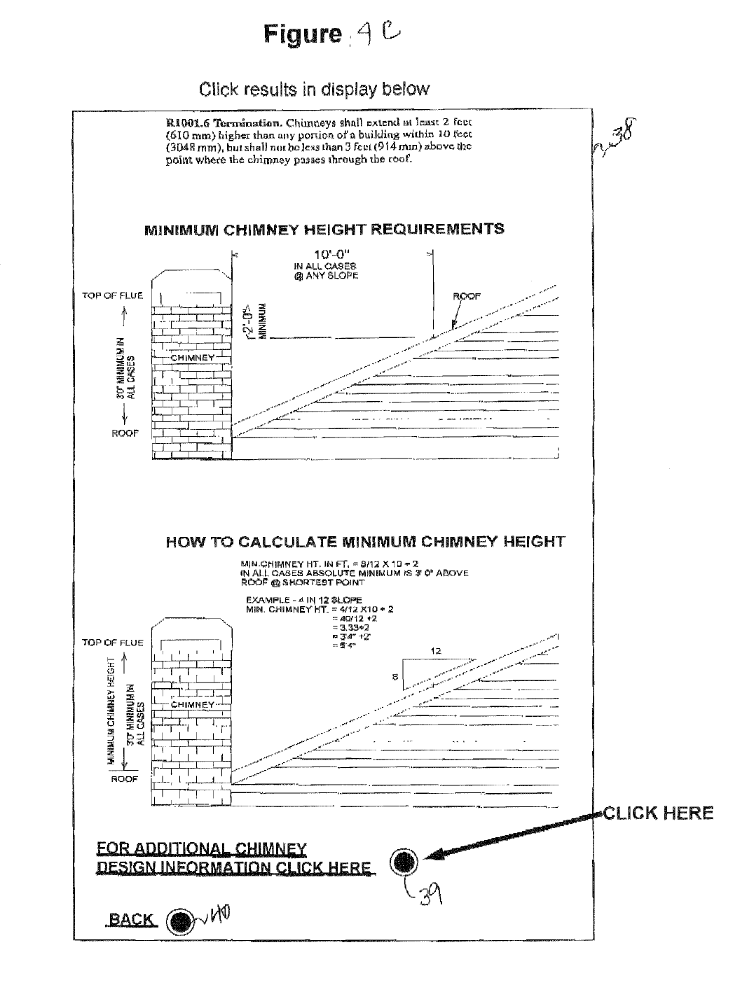

An advantage of the exemplary embodiment is that a user may zoom in or out with respect to a particular area on a page of an exemplary set of plans of the exemplary embodiment. By enlarging an area of a page from an exemplary set of plans, a user may be able to view details. By zooming out, the user may be able to gain an overview of the information included on the page. In the example provided herein, the home owners 12, 14 and project manager 16 have caused the enlargement of the area 30 around the chimney feature 32 on the rear elevation 28b of sheet A-4 Elevations and Sections 22. The enlargement is shown in FIG. 4A. This enlargement may be displayed on a separate screen from that of display of sheet A-4 Elevations and Sections 22, it may be displayed in a cascaded manner with the sheet 22, or otherwise.

The home owners 12, 14 and project manager 16 may obtain code information about the chimney feature 32 by selecting that feature by clicking on its associated button 33 or otherwise activating it. In this embodiment, the chimney feature 32 may be activated from either screen A-4 Elevations and Sections 22 or the enlargement of the area 30. Thus, in an exemplary embodiment of the invention, a user may access code information relating to a feature in the set of plans wherever that feature appears in the set of plans, if that feature is a selectable feature.

The code information associated with the chimney feature 32 in this exemplary embodiment and that is displayed includes the part of the code relating to chimneys and fireplaces 34 as illustrated in FIG. 4B.

The code information that is displayed in response to activation of the chimney feature 32 may be based also on one or more characteristics supplied by the user or otherwise designated such as the geographic location of the building or project. A default characteristic may be provided when no other characteristic is provided. For example, if a user supplies the location of a building as a particular municipality within a particular county within a particular state, then the code information that is displayed may be relevant to those supplied geographic locations. Advantageously, the user does not have to read through irrelevant code information.

FIG. 4B illustrates an advantage of the exemplary embodiment that allows the user to close or undisplay the display of illustrated information by activating the “back” button 35. The undisplay of this illustrated information may mean that the screen or other view containing or displaying the illustrated information is closed or otherwise hidden from view. Advantageously, the user may be returned by the exemplary embodiment to a view of the previous open screen after activating the “back” button 35. Thus, a user does not have to be concerned about losing his or her place when using the exemplary embodiment.

FIG. 4B also illustrates an advantage of the exemplary embodiment that allows the user to obtain further information from a display of code information such as shown in FIG. 4B. One way the user obtain further information is to click on the button 36 marked “For Additional Chimney Design Information”. This button 36 is linked to additional chimney design information, and activation of the button 36 results in a display of such information.

The exemplary embodiment, however, allows the user to find even more information relating to an element of the displayed code information. For example, assume the user desires further information relating to that element of the code information illustrated in FIG. 4B and entitled “R1001.6 Termination” 37. Advantageously, this element of the displayed code information is linked with relevant element information. Upon activation of the element R1001.6 Termination”, relevant element information 38 may be displayed such as that information illustrated in FIG. 4C. The relevant element information also may be based on the one or more characteristics such as geographic location supplied by the user, or a default characteristic, or otherwise.

A user may obtain further information from the information displayed in FIG. 4C by clicking on the button 39 “For Additional Chimney Design Information” (which may or may not display the same information as would be presented in the button 36 “For Additional Chimney Design Information” shown on FIG. 4b). In addition, the displayed information in FIG. 4C may include elements that may be associated with relevant element information, and activation of an element may cause its associated relevant element information to be displayed. As with the other displays of information, the information displayed in FIG. 4C includes a “back” button 40 to return the user to a previously viewed page or otherwise.

Alternative embodiments of the inventions may include further iterations than just the two iterations above shown in FIGS. 4B and 4C of displayed information that may include selectable elements that may be activated for relevant element information, that may include “additional information” buttons, and/or that may include “back” buttons. Moreover, some pages of a set of plans may have no selectable features. In some cases, a page may have selectable features that may be linked to respective code information, but one or more of the displays have code information may fail to have selectable elements.

To summarize the chimney compliance example, the homeowners 12, 14 and project manager 16 may access the software application 18, provide the geographic location of the home 11, and view the cover sheet 20 as shown in FIG. 2. From the cover sheet 22, the homeowners 12, 14 and project manager 16 may begin their research for code information about the chimney 17 by determining that an exemplary chimney feature 32 appears on a sheet A-4 Elevations and Sections 22 as shown in FIG. 3. They may enlarge the area 30 to get a better view of the chimney feature 32 as illustrated in FIG. 4A. From either the display shown in FIG. 3 or in FIG. 4A, the homeowners 12, 14 and project manager 16 may indicate selection of the exemplary chimney feature 32 by activating an associated button. In response to that activation, code information such as shown in FIG. 4B may be displayed. For further information, the homeowners 12, 14 and project manager 16 may activate a selectable element found in the code information such as “R1001.6 Termination” 37, and as a result, relevant element information 38 as illustrated in FIG. 4C may be displayed. With respect to the displayed information in either FIG. 4B or 4C, the homeowners 12, 14 and project manager 16 may be provided with additional information by activating the “additional information” buttons 36, 39, respectively. The homeowners 12, 14 and project manager 16 do not have to worry about getting lost in the information because they may use the “back” buttons on the various pages to return to a starting point or otherwise.

From the foregoing description of the exemplary embodiments of the inventions and operation thereof, other embodiments will suggest themselves to those skilled in the art. Therefore, the scope of the inventions is to be limited only by the claims below and equivalents thereof

We claim:

1. With respect to a feature included in a set of plans, a method of providing access to and information about a code or codes, or part or parts thereof, that is or are relevant to the feature, comprising;
providing an exemplary set of plans displaying one or more exemplary features;
causing at least one of the one or more exemplary features to be selectable to indicate a selection of an exemplary feature from the one or more exemplary features;
receiving an indication of a selected exemplary feature;
receiving an identification of a geographic location;
using the indication of the selected exemplary feature and the identified geographic location to find code information including at least a part or parts of a code or codes relevant to the selected exemplary feature and the identified geographic location, and also including associated information; and
displaying the code information.

2. The method of claim 1, wherein the exemplary set of plans includes one or more pages with a page including at least a plan relevant to the exemplary set of plans.

3. The method of claim 2, wherein one of the one or more pages of the exemplary set of plans comprises
a cover page having items including
an index of the one or more pages of the set of plans,
a site plan, or
one or more lists of topics of code information with each list including one or more entries;
wherein the items are selectable; and further comprising:
causing each selectable item to be associated with respectively relevant information; and
responding to activation of an item by displaying relevant information associated with the item.

4. The method of claim 1, wherein the associated information included with the code information comprises at least an illustration.

5. The method of claim 1, wherein the displayed code information comprises a selectable undisplay button; and
further comprising:
responding to activation of the undisplay button by undisplaying the g code information.

6. The method of claim 5, further comprising:
after undisplaying the code information, displaying the selected exemplary feature.

7. The method of claim 1, wherein displaying the code information comprises displaying the code information and the selected exemplary feature.

8. The method of claim 7, wherein displaying the code information and the selected exemplary feature comprises displaying the code information and the selected exemplary feature in a split screen format.

9. The method of claim 1, wherein the displayed code information comprises one or more selectable elements;
wherein each selectable element is associated respectively with relevant element information; and
further comprising:
responding to activation of a selected element by displaying the associated relevant element information.

10. The method of claim 9, wherein the display of the associated relevant element information is provided in a cascaded fashion with the display of the code information.

11. With respect to a particular project having a particular set of plans, a method of providing code information related to the project and providing access to the code information, comprising:
identifying one or more features in the particular set of plans;
causing each of the identified features to be associated respectively with a link to an applicable part or parts of code information;
causing an applicable part of the code information to include at least a part of a code related to an associated identified feature; and
in response to activation of a link associated with an identified feature, causing display of at least the applicable part of the code information associated with the identified feature.

12. The method of claim 11, wherein the code information comprises explanatory information.

13. The method of claim 11, further comprising:
determining the applicable part or parts of the code information to be associated with a particular identified feature based at least in part on geographic location of the particular project.

14. The method of claim 11, wherein the applicable part of the code information comprises at least the part of a code relating to the associated identified feature, at least a part of a second code relating to the associated identified feature, and explanatory information.

15. A method of providing code information, comprising:
providing an exemplary set of plans including one or more features;
causing each feature to be associated respectively with a link to code information; and
in response to activation of a link associated with a feature, causing the display of the code information pertaining to the feature.

16. The method of claim 15, wherein the code information comprises code information by zip code; and further comprising:
causing a zip code to be provided; and
wherein causing the display of the code pertaining to the feature comprises causing the display of the code pertaining to the feature and based on the provided zip code.

17. A method to present one or more parts of a code relevant to a feature in a plan, comprising:
receiving a request for code information with the request identifying a geographic location and a feature from a plan;
using the geographic location and the feature to determine one or more parts of one or more codes; and
causing a display of the code information determined from the identified geographic location and the feature from the plan.

18. The method of claim 17, further comprising:
causing information associated with the code information to be displayed with the code information.

19. A method for providing a source of information about regulations governing features in a plan, comprising:
compiling regulations relating to exemplary features of an exemplary plan; and
with respect to each exemplary feature of the exemplary plan, associating feature information
including one or more regulations relevant to that feature and based on geographic location, and
including information about the one or more relevant regulations; and
causing the exemplary plan with the exemplary features and associated feature information to be made available as a source of information.
